(19) United States
(12) Patent Application Publication
(10) Pub. No.: US 2006/0196091 A1
(43) Pub. Date: Sep. 7, 2006

(54) Retractable self-leveling ceiling sign hanger

(75) Inventors: Annette Ricci, Lake Forest, IL (US); Marta Gonzalez, Aurora, IL (US); Michael Yurkovic, Park Ridge, IL (US)

Correspondence Address: KNECHTEL DEMEUR & SAMLAN;ATTN: ALAN B. SAMLAN, 222 S. RIVERSIDE, SUITE 1410, CHICAGO, IL, 60606, US

(73) Assignee: Design and Deliver Incorporated

(21) Appl. No.: 11/070,448

(22) Filed: Mar. 1, 2005

(51) Int. Cl. G09F 7/00

(52) U.S. Cl. 40/601

(57) ABSTRACT

An apparatus and method for providing a retractable self-leveling ceiling sign hanger. The apparatus comprises of a sign housing having an upper housing and a lower housing, a cord reel housing, and a cord that forms a continuous loop between the sign housing and the cord reel housing. The sign housing and the cord reel housing coact to transfer or extend cord between them to thereby raise and lower the lower housing in a level position for installing, changing, and hanging a sign. The sign housing utilizes roller assemblies and a cord lock mechanism. The cord reel housing utilizes a handle, a tool, a locking means, and a cord retracting means for moving the cord reel housing and transferring or extending cord to and from the cord reel housing. Magnets are also provided to affix the cord reel housing to the upper housing of the ceiling sign hanger.

### I. FIELD OF THE INVENTION

The present invention relates to hanging devices and, more particularly, to a self-leveling retractable hanging mechanism for hanging signs, posters, banners, and the like from ceilings.

### II. DESCRIPTION OF THE PRIOR ART

Many hanger devices have been invented for hanging signs, advertising materials, or other materials from suspended ceilings. This is usually done by attaching one end of a string or wire to a metal hanger that is attached to a cross brace that supports the suspended ceiling with the other end of the string or wire being attached to the sign. This process requires the person hanging the sign to place a ladder under the area where the sign is to be hung, climb the ladder to reach the suspended ceiling, and attach one end of the string to the ceiling brace. If a second string or wire is used, the process must be repeated. The appropriate length of the string is then let out and the opposite or loose end of the string is attached to the sign. This process is likewise repeated for the second string. Each time a new sign is hung, these strings may or may not be replaced. However, the old sign is always removed and a new sign is attached to the loose ends of each string. If the original strings are reused, the height of the sign is already set. If the original strings are replaced, the length of the strings must also be measured to set the desired height of the sign. This presents a problem as the exact amount of each string must be precisely measured from the ceiling or the sign will not be level.

These types of hanging devices also present a safety problem when repeatedly installing or changing signs. For example, a ladder used for accessing the hanging device is generally in a location where people such as shoppers, employees, etc. may be present which facilitates the potential for injury to these persons. Among the laundry list of foreseeable and unforeseeable injurious situations, the tools used in hanging the sign may fall off the ladder injuring these persons, the installer may fall off the ladder when attaching the sign, and/or any number of other problems could arise during the installation or changing of the sign from the strings. The more times the installer has to climb the ladder, the greater the risk of injury and/or the potential for injury. Thus, it would be a great improvement over the prior art if the signs for the hanging devices could be changed by a person while standing on the floor.

Various clips have been designed in the past that attach to ceiling members. One example is illustrated in U.S. Pat. No. 5,082,227 to Insko. This illustrates a hanger and tool that attaches to a suspended ceiling. The tool allows the hanger to be attached to the ceiling support members while the installer remains on the floor. However, this device does not illustrate a self-leveling mechanism, nor does it provide a string or cable with which to attach the sign in a self-leveling arrangement.

Another device that does provide for self leveling is illustrated in U.S. Pat. No. 6,634,610 to Applicant, Design and Deliver Incorporated. A shortcoming of this device is that it is limited to signs weighing no more than approximately two (2) to five (5) pounds.

Thus, there is a need and there has never been disclosed Applicant's unique retractable self-leveling ceiling sign hanger.

### III. OBJECT AND ADVANTAGES

It is the primary object of the present invention to provide a hanger for hanging signs from a ceiling that utilizes a self-leveling mechanism to automatically and continuously levels the sign with respect to the floor or ground.

Another object of the present invention is to provide a ceiling sign hanger that allows the installer to change the sign while standing on the ground once the ceiling sign hanger housing is attached to the ceiling supports.

Another object of this invention is to provide a ceiling sign hanger that has a cable that extends from and retracts into the ceiling sign hanger housing by means of a spring-loaded reel. This provides the advantage of allowing the sign to be lowered to the ground by manipulating the spring-loaded reel to change the sign.

Another object is to provide a ceiling sign hanger that has locking means to precisely control the length of cable removed from the reel enabling the sign to be installed or changed and/or displayed a selected height above the floor.

Still another object of the present invention is to provide a ceiling sign hanger that easily attaches to suspended ceiling support members.

Still another object is to provide a ceiling sign hanger that is economical to manufacture and safe and easy to operate.

Yet another object is to provide a ceiling sign hanger that can hold signs weighing up to approximately fifteen (15) pounds.

Other objects of the present invention will become more apparent to persons having ordinary skill in the art to which the present invention pertains from the following description taken in conjunction with the accompanying drawings.

### IV. SUMMARY OF THE INVENTION

The present invention is an apparatus and method for providing a retractable self-leveling ceiling sign hanger. The apparatus comprises a sign housing having an upper housing and a lower housing, a cord reel housing, and a cord that forms a continuous loop between the sign housing and the cord reel housing. The sign housing and the cord reel housing coact to transfer or extend cord between them to thereby raise and lower the lower housing in a level position for installing, changing, and hanging a sign. The sign housing utilizes roller assemblies and a cord lock mechanism. The cord reel housing utilizes a handle, a tool, a locking means, and a cord retracting means for moving the cord reel housing and transferring or extending cord to and from the cord reel housing. Magnets are also provided to affix the cord reel housing to the upper housing of the ceiling sign hanger.

### V. BRIEF DESCRIPTION OF THE DRAWINGS

The Description of the Preferred Embodiment will be better understood with reference to the following figures:

FIG. 1 is front perspective partial cutaway view of the ceiling sign hanger of the present invention.

FIG. 2a is an enlarged perspective view, with portions removed, of the upper housing of the ceiling sign hanger.

FIG. 2b is a cross sectional view, taken along line 2b-2b of FIG. 2a, of the upper housing of the ceiling sign hanger.

FIG. 2c is a front view, with portions removed, of the upper housing of the ceiling sign hanger illustrating the mounting holes for attachment to the end caps.

FIG. 3a is a top view of the cord reel housing.

FIG. 3b is a front view of the cord reel housing.

FIG. 3c is a side view of the cord reel housing with the cover removed exposing the internal components.

FIG. 3d is a side view of the cord reel housing.

FIG. 4a is a front view of the lower housing of the ceiling sign hanger.

FIG. 4b is an end view of the lower housing of the ceiling sign hanger illustrating the roller assembly and sign securing holes located in the lower housing end caps.

FIG. 4c is a front view of the lower housing end caps.

FIGS. 5, 6, and 7 are front views of the ceiling sign hanger as it would appear during the process to install or change a sign.

### VI. DESCRIPTION OF THE PREFERRED EMBODIMENT

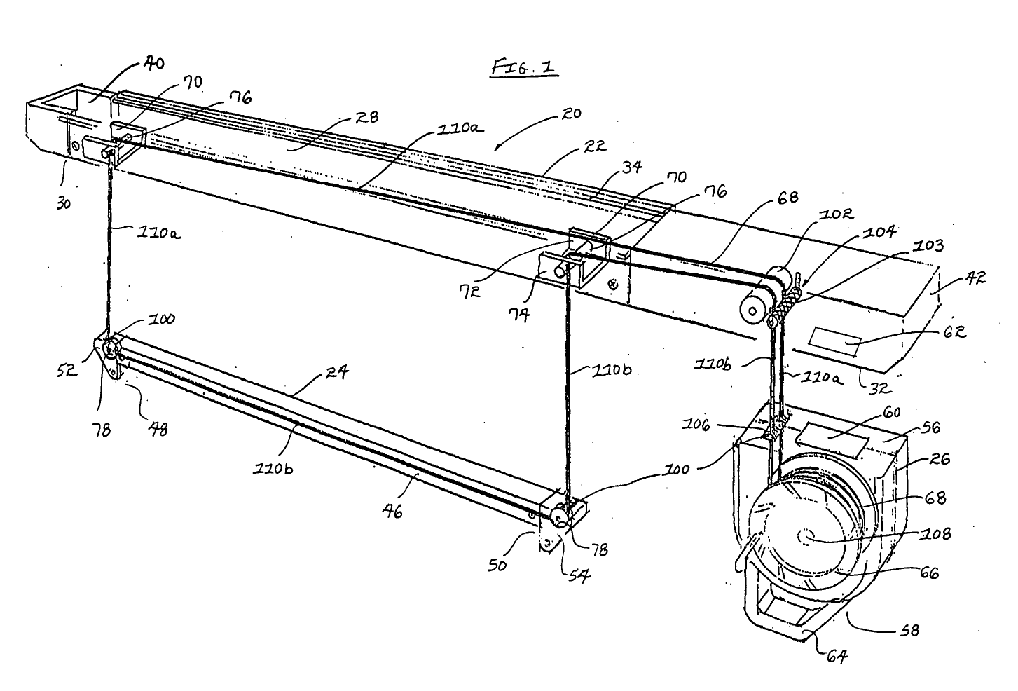

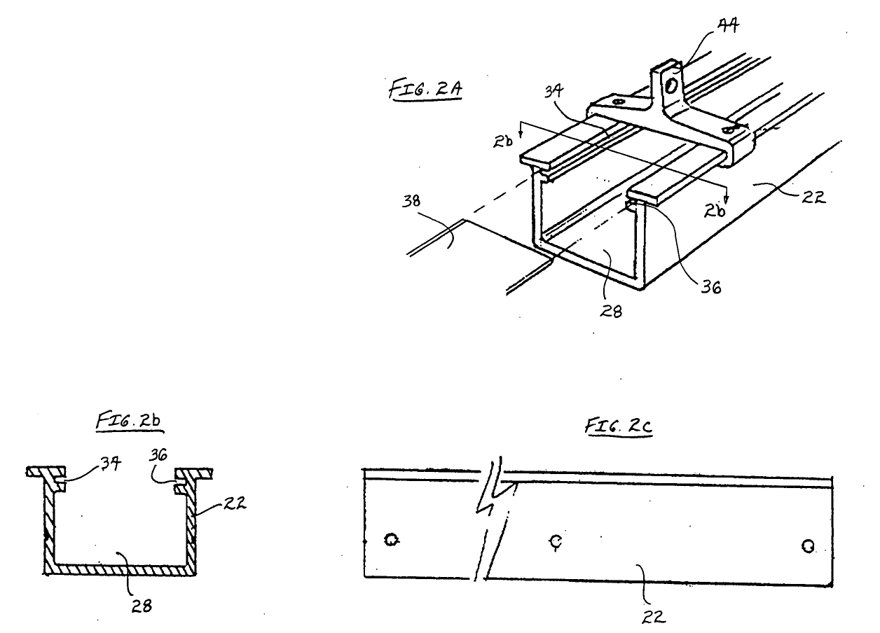

Turning to FIG. 1 there is illustrated a ceiling sign hanger 20 of the present invention. The ceiling sign hanger 20 has an upper housing 22, a lower housing 24, and a cord or cable reel housing 26. Preferably, the upper housing 22 is a U-shaped rectangular member having an elongated trough 28 that extends along the upper housing 22 between ends 30 and 32 (see also FIG. 2b). The upper housing 22 may be made of any rigid material including but not limited to steel, aluminum, or plastic. Channels 34 and 36 (FIGS. 2a and 2b), located on each side of the U-shaped rectangular member of the upper housing 22, likewise extend along the upper housing 22 between ends 30 and 32. Channel 34 is identical to and opposite channel 36. In combination, channel 34 and channel 36 are designed to slidably receive a cover 38 (FIG. 2a). Preferably, the cover 38 extends into and along the entire length of the channels 34 and 36 from end 30 to end 32. The cover 38 is made of a waterproof or water resistant material and is sealed within the channels 34 and 36 using a silicon or, alternatively, any other form of waterproof or water resistant type sealant.

Referring back to FIG. 1, a pair of roller assemblies 70 are situated within the trough 28. The roller assemblies 70 have opposed walls 72 and 74 securing a guide roller 76 between them. Each opposed wall 72 and 74 are located against adjacent interior walls of the upper housing 22 below channels 34 or 36, respectively. The guide roller 76 is cylindrical in shape and extends across the entire width of the trough 28 from one opposed wall 72 to the other opposed wall 74. Using the opposed walls 72 and 74, the roller assembly 70 may be fixedly attached or, alternatively, frictionally engaged within the trough 28 to the upper housing 22. In the preferred embodiment, there are two roller assemblies 70. One roller assembly 70 is located adjacent to end 30 and the other roller assembly 70 is located toward the other end 32. The precise location of the roller assemblies 70 depends upon the length of the lower housing 24. In the preferred embodiment and for the reasons discussed later herein, the roller assemblies 70 are each situated directly above and aligned with a corresponding lower housing end caps 52 and 54 of the lower housing 24.

Adjacent to end 32 is the combination of a large guide roller 102 and a knurled cord lock 104 having a plurality of locks 103. The large guide roller 102 and the knurled cord lock 104 are each cylindrical in shape and extend across the entire width of the trough 28. In the preferred embodiment, the large guide roller 102 has a diameter which is larger than the size of the diameter of the knurled cord lock 104. The function of the combination of the large guide roller 102 and knurled cord lock 104 using the plurality of locks 103 is to squeeze and/or release a piece of cord between them. When the cord or cable is squeezed, any movement of the cord between the large guide roller 102 and the knurled cord lock 104 is restricted. When the cord is released, the free movement of the cord between the large guide roller 102 and knurled cord lock 104 is permitted. This locking means is known to one skilled in the art and disclosed in the prior art.

The upper housing 22 is also provided with upper housing end caps 40 and 42. In this manner, the U-shaped rectangular member of the upper housing 22, the cover 38, and the upper housing end caps 40 and 42 coact to isolate and securely enclose the trough 28 and the roller assemblies 70 located within the trough 28. The upper housing 22 is designed to be attached to or suspended from a ceiling (not illustrated) using brackets 44 (FIG. 2a). Alternatively, any other means for securing the upper housing 22 to a ceiling is acceptable provided that this means does not interfere with the use of the device.

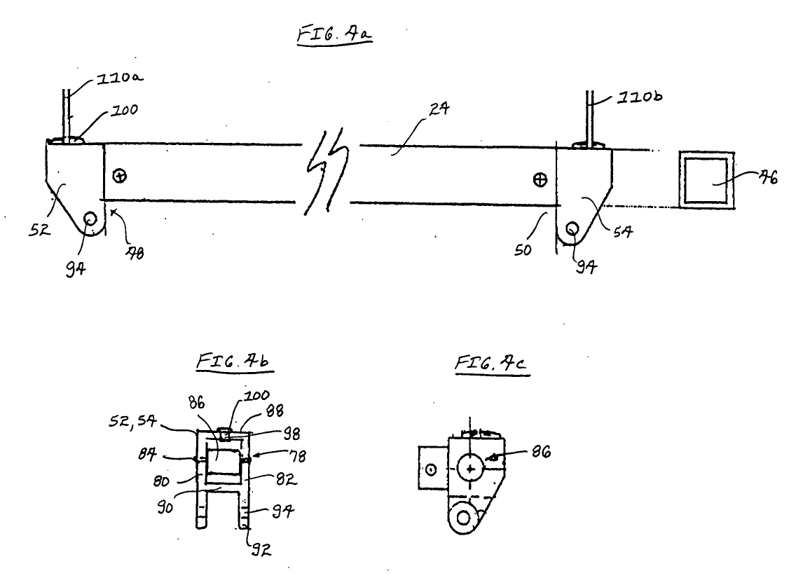

The lower housing 24 is preferably a square shaped rectangular member having an elongated lower channel 46 that extends along the lower housing 24 between ends 48 and 50 (see also FIG. 4a). The lower housing 24 is also provided with lower housing end caps 52 and 54. In this manner, the square shaped rectangular member of the lower housing 24 and the lower housing end caps 52 and 54 coact to isolate and securely enclose the lower channel 46.

A pair of lower housing roller assemblies 78 are situated within each lower housing end caps 52 and 54. Referring to FIG. 4b, the roller assembly 78 consists of sidewalls 80 and 82, a center bar 84 fixedly attached to and extending perpendicularly from sidewall 80 to sidewall 82, and a roller 86 disposed around the entire circumference of the center bar 84. The roller assembly further comprises a top wall 88 and a bottom wall 90. The combination of the top wall 88, the sidewalls 80 and 82, and the bottom wall 90 coact to form a housing of the roller assembly 78 and a means for isolating and securely enclosing the roller 86 within the lower housing end caps 52 and 54. In each lower housing end cap 52 and 54, the top wall 88 is provided with an opening 98. The opening 98 is preferably filled with a bristled cap 100. In the preferred embodiment, prior to a cord entering or exiting through the bristled cap 100, the bristled cap 100 removes unwanted foreign particles that have attached themselves to the cord. The bristled cap 100 also functions as a cover to restrict dust and dirt from entering the lower housing 24.

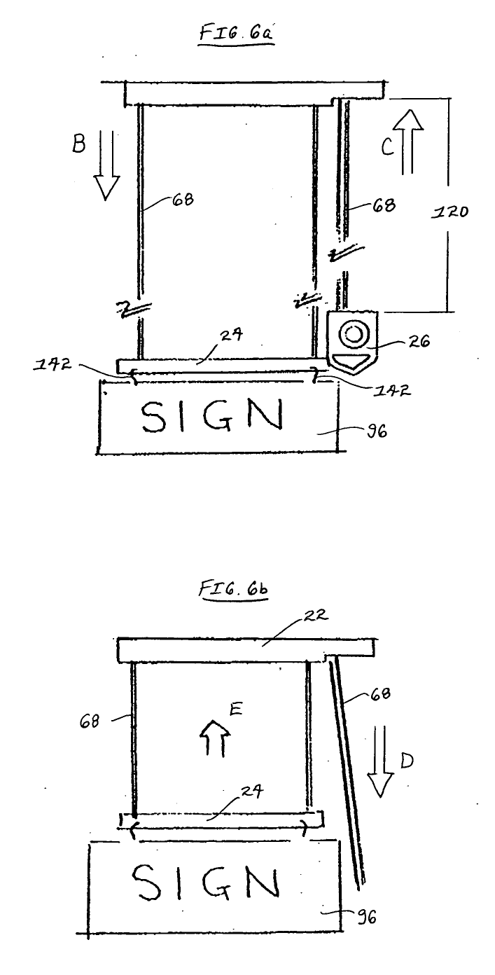

Situated below the roller assembly 78 in each of the lower housing end caps 52 and 54 are prongs 92. Prongs 92 are correspondingly aligned with sidewalls 80 and 82, respectively, and extend outwardly from bottom wall 90. Each prong 92 is provided with holes 94. In the preferred embodiment, holes 94 are the means for securing or attaching a sign 96 (see FIG. 6) to the lower housing 24.

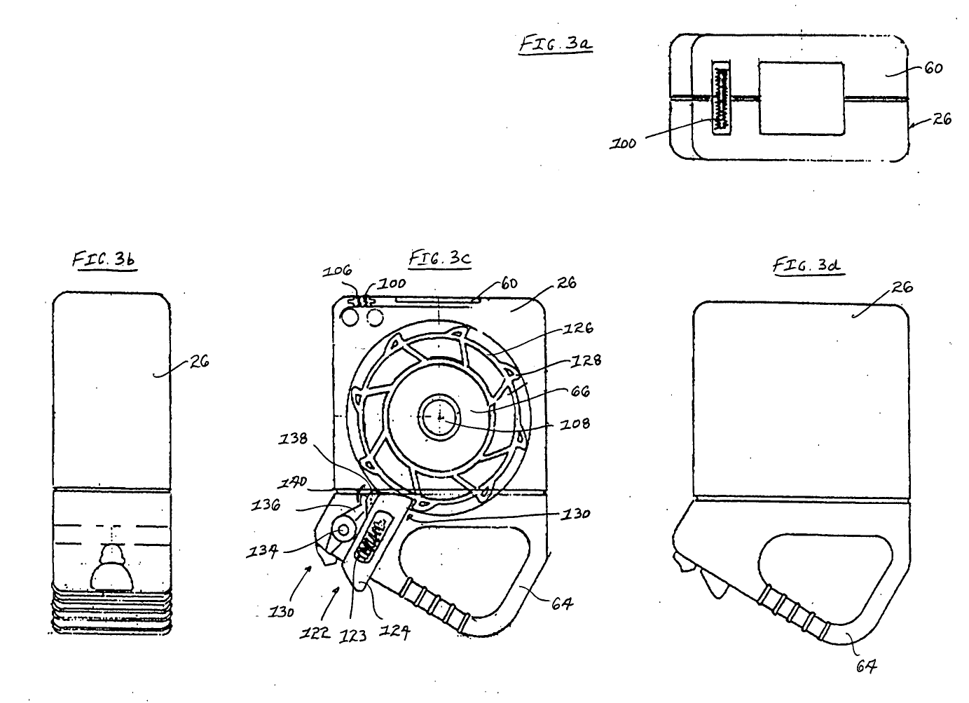

Referring back to FIG. 1, the cord reel housing 26 has a top side 56 and a bottom side 58. In the preferred embodiment, a magnet 60 is integrally formed in the top side 56 (refer also to FIGS. 3a and 3c). Alternatively, the magnet 60 may be affixed to the top side 56 of the cord reel housing 26 by adhesive, a bonding agent, or any other means known to a person skilled in the art; provided that, this magnet attachment means is sufficient to remain fixed to the cord reel housing 26 during repeated attachment and detachment of the cord reel housing 26 to and from the upper housing 22 as further discussed herein. The magnet 60 is of sufficient size and magnetic strength to affix the cord reel housing 26 to the upper housing 22. If the upper housing 22 is made of steel or other magnetic material, the magnetic 60 will automatically be attracted to the magnetism of the upper housing 22 for attaching the cord reel housing 26 to the upper housing 22. If the upper housing 22 is made of a non-magnetic material, the upper housing 22 may be provided with a complementary magnet 62.

In the preferred embodiment, the cord reel housing 26 is located on the right side of the upper housing 22 adjacent to end 32. Alternatively, the cord reel housing 26 may be located on the left side of the upper housing 22 adjacent to end 30 provided the device is reversed to work in the same manner described herein.

Also located within the top side 56 of the cord reel housing 26 is an aperture 106 (see also FIG. 3c). The aperture 106 is filled with the same bristled cap 100 as in the lower housing end caps 52 and 54. The bottom side of the cord reel housing 26 is also provided with a handle 64.

Within the cord reel housing 26 is a spool 66 wound with cable or cord 68. It is anticipated that the cord 68 is substantially thirty feet (30′) in length. Alternatively, the length of the cord 68 may be greater or smaller depending upon the size and location of the ceiling sign hanger 20, the sign it is intended to hang, and the height of the ceiling from which the sign is hung.

Cord 68 is a single cord having two ends. One end of the cord 68 is attached to a core 108 of the spool 66 while the other end of the cord 68, as discussed in more detail below, is threaded from the cord reel housing 26 up through the upper and lower housings and then returning back into the cord reel housing 26 for attachment to the core 108 of the spool 66 as well. For identification purposes, the cord 68 is referred to as identical cord strands 110a and 110b.

Cord strands 110a and 110b are each wound around core 108 of the spool 66. After being wound around the core 108 of the spool 66, the remainder of each cord strand 110a and 110b extends from the spool 66 parallel to each other. Both cord strands 110a and 110b exit through the aperture 106 and bristled cap 100 of the top side 56 of the cord reel housing 26 in the direction toward the upper housing 22. Cord strand 110a and 110b are each received into the upper housing 22 and routed between the large guide roller 102 and knurled cord lock 104 as illustrated in FIG. 1. Cord strand 110a and 110b are each then routed over the exterior surface of the large guide roller 102 and into the trough 28 in the direction toward end 30 of the upper housing 22. When cord strands 110a and 110b each reach the first roller assembly 70, cord strands 110a and 110b diverge from one another. Cord strand 110b continues over the top of the first guide roller 76 and immediately rotates through ninety degrees (90°) around the exterior of the guide roller 76 exiting the upper housing 22 in the direction toward the lower housing 24. Cord strand 110a likewise continues over the top of guide roller 76 and then continues through trough 28 toward the next roller assembly 70 adjacent to end 30. Once cord strand 110a reaches the next roller assembly 70, cord strand 110a rotates through ninety degrees (90°) around the exterior of the guide roller 76 of the roller assembly 70 exiting the upper housing 22 in the direction toward the lower housing 24.

In identical fashion and having both exited the upper housing 22, cord strands 110a and 110b are each inserted through the bristled cap 100 and opening 98 to be received into lower housing end caps 52 and 54 of the lower housing 24, respectively. Cord strand 110b enters roller assembly 78 at end 50 and rotates through ninety degrees (90°) around the exterior of roller 86. Cord strand 110b then continues through the lower channel 46 of the lower housing 24 toward the next roller assembly 78 adjacent end 48. Cord strand 110a enters roller assembly 78 at end 48 and integrally connects at ninety degrees with cord strand 110b around the exterior of the roller 86. In this manner, cord 68 forms a single, continuous cord strand or closed loop cord throughout the entire ceiling sign apparatus 20.

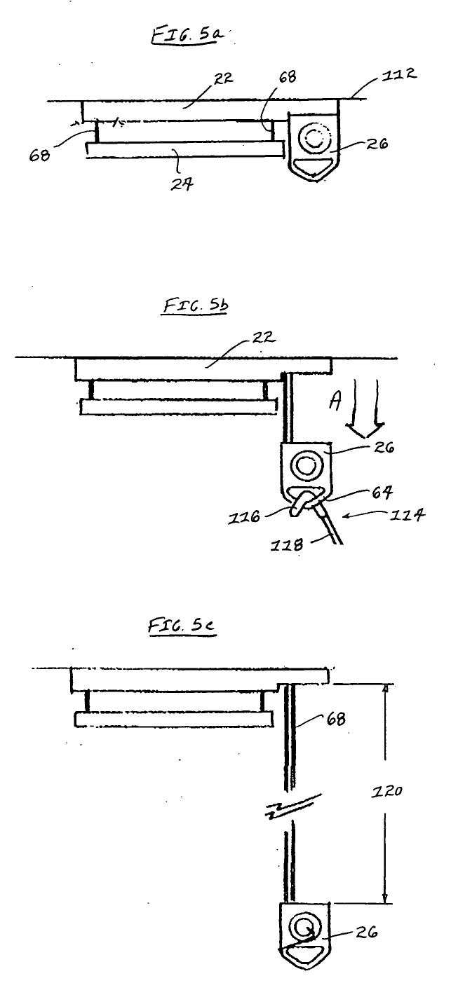

To use the ceiling sign hanger 20, upper housing 22 must be mounted to a suspended ceiling 112. This requires a ladder or other elevated support. The brackets 44 are fastened to support members attached to the ceiling. These attach the upper housing 22 to the ceiling 112 at the location where the sign is to hung. Once the upper housing 22 is attached to the ceiling 112, as illustrated in FIG. 5a, the ladder is no longer required to install or change the sign. The only reason a ladder would again be needed would be if the location of the sign had to be changed, in which case, the ceiling sign hanger 20 would be required to be moved. As illustrated, the ceiling sign hanger 20 is in its top or raised position. The cord reel housing 26 is magnetically attached to the upper housing 22, the cord 68 is locked between the cord locking mechanism of the large guide roller 102 and knurled cord lock 104, and the lower housing 24 is resting adjacent to the upper housing 22.

To begin the process of installing or changing a sign, a tool 114, as illustrated in FIG. 5b, is used. The tool 114 has a head 116 at the end of a telescoping pole 118. The pole 118 is extended until the head 116 grasps the handle 64 of the cord reel housing 26. The user then pulls down on the handle 64 in the direction of arrow A with sufficient force to overcome the magnetism between the cord reel housing 26 and the upper housing 22 and release the cord reel housing 26 from the upper housing 22. The cord reel housing 22 is pulled down a desired distance 120 releasing cord 68 from the cord reel housing 22 as illustrated in FIG. 5c. For example, if the cord 68 has a total length of thirty feet (30′), the maximum distance 120 would be slightly less than one-half of the total length or fifteen feet (15′) and this would be substantially the length of cord 68 released from the cord reel housing 22. The cord reel housing 22 is then locked to maintain this distance 120 and length of cord 68.

The cord reel housing 22 is locked using a locking means 122 as illustrated in FIG. 3c. The locking means 122 consists of a spring loaded lever 124, a ratchet 126 having a plurality of detents 128, and a locking member 130. When the cord reel housing 26 is being lowered, the spring loaded lever 124 rests in the disengaged position and does not engage or come in contact with the spool 66. In this manner, the spool 66 freely rotates about the core 108 releasing cord 68. When the desired distance 120 (FIG. 6a) is reached and sufficient length of cord 68 released, the spring loaded lever 124 is depressed. Overcoming the opposite force applied by a compressed spring 123, the spring loaded lever 124 is situated adjacent to the ratchet 126 between any of the plurality of detents 128. Upon reaching this location, one of the plurality of detents 128 engages the spring loaded lever 124 at contact point 132. The locking member 130 is actuated forward pivoting around collar 134 until arm 136 engages a ramp 138 on the spring loaded lever 124 and is positioned on the inside of wall 140. In this manner, the locking member 130 becomes wedged between the ramp 138 of the spring loaded lever 124 and the wall 140 thereby locking the cord reel housing 26 in its current position. As a result, the locking means 122 restricts or stops the cord retracting means of the cord reel housing 26 from applying an opposite rotative force to the spool 66 from a spring means for causing the spool 66 from rotating and winding the cord 68 any further about the core 108.

The cord 68 is locked and released from the upper housing 22 by means of a cord locking mechanism such as commonly found in window blinds. The operation is more clearly illustrated in FIGS. 6a and 6b. Referring to FIG. 6a, the cord reel housing 26 is pivoted to one side from its vertical position to disengage the cord locking means and release the cord 68 from being squeezed between the large guide roller 102 and the plurality of locks 103 of the knurled cord lock 104. With the cord 68 released, gravity causes the lower housing 24 to move in the direction of arrow B away from the upper housing 22. As the lower housing 22 moves downward, the excess cord 68 hanging between the upper housing 22 and the cord reel housing 26 is fed through the upper housing 22 and lower housing 24 of the ceiling sign hanger 20. As the cord 68 is fed through the ceiling sign hanger 20, cord strand 68, through cord strands 10a and 10b, is guided by the respective roller assemblies 70 of the upper housing 22 to the lower housing 24. As the identical length of cord strand 110a and 110b exits the upper housing 22, the lower housing 24 is correspondingly lowered by this length toward the ground while continuously remaining in a level position by the cord 68. As the cord 68 passes freely through the upper housing 22 and the lower housing 24, the identical length of cord strands 110a and 110b cooperate to lower each lower housing end cap 52 and 54 the same distance and at the same rate, thereby, self-leveling the ceiling sign hanger 20. Should the cord 68 lower either the lower housing end cap 52 or lower housing end cap 54 more than the other, the lower housing 24 can be adjusted by permitting more or less cord 68 to be transferred through the lower channel 46 to raise or lower the ends of the lower housing 24 and enabling the lower housing 24 to remain in a level position. Simultaneously, the cord reel housing 26, still remaining locked, moves in the direction of arrow C to accommodate the movement of cord 68 and permit this length of cord 68 to be fed through the ceiling sign hanger 20. When the lower housing 24 is within reach, the cord reel housing 26 is pivoted to the other side from its vertical position to re-engage the cord locking means thereby securing the cord 68 and locking the lower housing 24 in position, also referred to as its changing position.

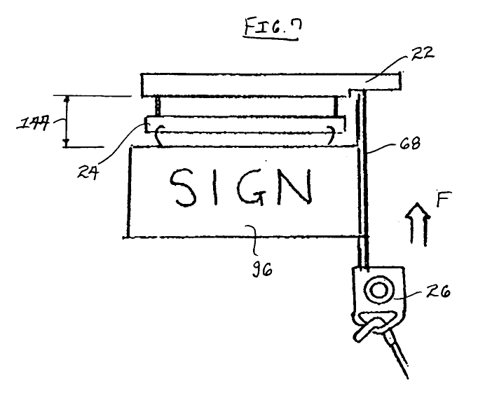

The sign 96 is then attached to the lower housing 24 using “s” clips 142. Alternatively, any other clips or mounting means may also be used to attach the sign 96 as will be apparent to those skilled in the art. The proper height that the sign 96 is to hang from the ceiling is then determined. Once determined, the cord reel housing 26 is again pivoted to the one side from its vertical position to again disengage the cord locking means and release cord 68. The cord reel housing 26, still remaining locked, is then pulled downward in the direction of arrow D as illustrated in FIG. 6b. As the cord reel housing 26 is pulled downward, cord 68, using cord strands 110a and 110b works in reverse through the ceiling sign hanger 20 by correspondingly pulling the lower housing 24 in the direction of arrow E from its changing position toward the upper housing 22. As the cord 68 is retracting, the cord 68 again maintains the lower housing 24 in a level position. When the proper height 144 is achieved, as illustrated in FIG. 7, the cord reel housing 26 is pivoted to the other side from its vertical position to re-engage the cord locking means thereby securing the cord 68 in the upper housing 22 and locking the lower housing 24 in its hanging position. Any remaining cord 68 that exists between the upper housing 22 and the cord reel housing 26 is then retracted back into the cord reel housing 26 by the cord retracting means once the locking means 122 on the cord reel housing 26 is released. To release the locking means 122, the locking member 130 is actuated in the reverse direction to release the arm 136 from the ramp 138. This enables the compressed spring in the spring loaded lever 124 to disengage the spring loaded lever 124 from the ratchet 126 and detent 128 and thereby permit the spool 66 to rotate counter clockwise and recoil the cord 68 around the spool 66. As the cord retracting means retracts the excess cord 68, the cord reel housing 26 moves in the direction of arrow F until it is again magnetically reattached to the upper housing 22 and placed back in its resting position.

By selecting the cord and individual of appropriate size and strength, the ceiling sign hanger can easily lift and hold signs of varying weights. Signs of up to fifteen (15) pounds have been supported by Applicant's device. By appropriate selection, it is believed that any size signs could be supported with the only limitation being the strength of the brackets and the supports to which they are attached.

Thus, there has been provided a self-leveling ceiling sign hanger that fully satisfies the objects and advantages as set forth above. While the invention has been described in conjunction with a specific embodiment, it is evident that many alternatives, modifications and variations will be apparent to those skilled in the art in light of the foregoing description. Accordingly, it in intended to embrace all such alternatives, modifications and variations as fall within the spirit and scope of the appended claims.

What is claimed is:

1. A sign hanging device for hanging signs from a ceiling comprising:
a sign housing having an upper housing and a lower housing;
means for attaching the upper housing to the ceiling;
a cable housing;
means for releasably attaching the cable housing to the upper housing;
a cable stored within the cable housing and extending out from the cable housing and into the sign housing on a first path and returning from the sign housing to the cable housing along a second path thereby forming a continuous loop;
first lowering means for releasing the cable housing from the upper housing and lowering the cable housing for providing an increased length of cable extending out from the cable housing;
cable retracting means mounted in the cable housing for retracting the increased length of cable back into the cable housing;
locking means mounted on the cable housing for stopping the cable retracting means from retracting the cable thereby determining the increased length of cable extending out from the cable housing and the size of the loop;
second lowering means for lowering the lower housing in a direction away from the upper housing to a lowered position using the increased length of cable extending out from the cable housing and passing the increased length of cable through the upper housing; and
means for hanging the sign from the lower housing.

2. The sign hanging device of claim 1 wherein the upper housing is made of a magnetic material.

3. The sign hanging device of claim 2 wherein the means for releasably attaching the cable housing to the upper housing comprises a magnet attached to one of the housings, the magnet and the material of the other housing providing a magnetic force between them to releasably attach the cable housing to the sign housing.

4. The sign hanging device of claim 3 wherein the first lowering means for releasing the cable housing from the sign housing and lowering the cable housing comprises a handle attached to the cable housing and an elongated tool for releasably attaching to the handle and pulling the cable housing in a direction away from the sign housing with sufficient pulling force to overcome the magnetic force thereby releasing the cable housing from the sign housing.

5. The sign hanging device of claim 1 wherein the cable retracting means comprises a reel and a spring means for applying a rotative force to the reel causing the reel to rotate and wind the cable onto the reel.

6. The sign hanging device of claim 5 wherein the cable has two ends, both ends connected to the reel of the cable housing.

7. The sign hanging device of claim 1 wherein the locking means comprises a moveable stopping member having a wedge that engages the reel and stops the reel from rotating and an articulated member having an arm that is articulated between a wall and the wedge for securing the stopping member engaged to the reel.

8. The sign hanging device of claim 1 wherein the second lowering means for lowering the lower housing in a direction away from the upper housing comprises a guide roller and a cord lock having a plurality of locks thereon, the guide roller and the plurality of locks retaining the cable between them until the cable is released from the plurality of locks thereby permitting the unrestricted passing of the increased length of cable between them.

9. The sign hanging device of claim 1 wherein the means for hanging the sign from the lower housing comprises securing holes from which the sign is hung.

10. The sign hanging device of claim 9 and further comprising clips for hanging the sign from the lower housing.

11. The sign hanging device of claim 1 wherein the upper housing and lower housing comprises a hollow tube through which the cable slidably passes.

12. The sign hanging device of claim 11 and further comprising roller assemblies in the hollow tubes for guiding the cable through the sign housing.

13. A sign hanging device for hanging signs from a ceiling, comprising:
an upper housing having an upper first end and an upper second end opposite the upper first end;
an upper hollow passageway between the upper first end and the upper second end;
a lower housing positioned below the upper housing, the lower housing having a lower first end and a lower second end opposite the lower first end, and a lower hollow passageway between the lower first end and lower second end;
a cable housing;
means for releasably attaching the cable housing to the upper housing;
a cable stored within the cable housing, the cable connecting the upper housing to the lower housing;
a cable path defined by the cable extending out from the cable housing and into the upper first end, through the upper hollow passageway, exiting the upper housing at the upper second end, entering the lower housing at the lower first end, through the lower hollow passageway, exiting the lower housing at the lower second end, re-entering and then re-exiting the upper housing at the upper first end, and returning to the cable housing thereby forming a continuous loop;
upper housing locking means for locking the cable within the upper housing and establishing the length of cable extending out from the upper housing to the lower housing and the distance between the lower housing and the upper housing;
means for releasing the cable stored within the cable housing to increase the size of the continuous loop thereby allowing the lower housing to move away from the upper housing due to gravity when the upper housing locking means is released;
cable retracting means in the cable housing for retracting the released cable;
cable housing locking means for stopping the cable retracting means from retracting the released cable thereby determining the increased length of cable extending out from the cable housing; and
means for attaching the sign from the lower housing.

14. The sign hanging device of claim 13 wherein the upper housing is made of a magnetic material.

15. The sign hanging device of claim 14 wherein the means for releasably attaching the cable housing to the upper housing comprises a magnet attached to the cable housing, the magnet and the material of the upper housing providing a magnetic force between them to releasably attach the cable housing to the upper housing.

16. The sign hanging device of claim 13 wherein the means for releasably attaching the cable housing to the upper housing comprises a magnet attached to each of the housings, the magnets providing a magnetic force between them to releasably attach the cable housing to the upper housing.

17. The sign hanging device of claim 13 wherein the upper housing locking means comprises two opposed rollers, one roller having a smooth surface and the other roller having a plurality of locks for frictionally retaining the cable between them.

18. The sign hanging device of claim 13 wherein the cable retracting means comprises a reel and a spring means for applying a rotative force to the reel causing the reel to rotate and wind the cable onto the reel.

19. The sign hanging device of claim 18 wherein the cable housing locking means comprises a moveable stopping member having a wedge that engages the reel and stops the reel from rotating and an articulated member having an arm that is articulated between a wall and the wedge for securing the stopping member engaged to the reel.

20. The sign hanging device of claim 13 and further comprising apertures situated adjacent each end of the lower housing.

21. The sign hanging device of claim 20 wherein the means for attaching the sign from the lower housing is a clip affixed to the apertures.

22. A method for hanging signs from a ceiling comprising the steps of:
providing a sign housing separated into an upper housing and a lower housing, the upper housing attached to a ceiling support member;
providing a cable housing releasably attached to the sign housing in a resting position;
storing a cable on a reel within the cable housing;
withdrawing the cable from the cable housing into the sign housing and returning the cable from the sign housing and back into the cable housing thereby forming a loop;
providing cable locking means mounted in the upper housing for locking the cable contained in the sign housing;
releasing the cable housing from the sign housing;
lowering the cable housing in a direction away from the sign housing for providing an increased length of cable extending out from the cable housing;
providing cable retracting means mounted in the cable housing for retracting the increased length of extended cable back into the cable housing;
providing locking means mounted on the cable housing for stopping the cable retracting means from retracting the increased length of cable back into the cable housing;
releasing the cable locking means for permitting the increased length of cable to freely flow through the sign housing;
lowering the lower housing in a direction away from the upper housing to a lowered position;
providing means for hanging the sign from the lower housing at the lowered position;
raising the lower housing in a direction toward the upper housing to a hanging position relative to the upper housing;
locking the cable contained in the sign housing using the cable locking means;
releasing the locking means for permitting the cable retracting means to retract the cable between the cable housing and the sign housing; and
raising the cable housing for returning the cable housing to the resting position with the sign housing.
